(19) United States
(12) Patent Application Publication
(10) Pub. No.: US 2013/0261516 A1
(43) Pub. Date: Oct. 3, 2013

(54) Hand Held Percussion Device

(71) Applicants: Joseph J. Cilea, Marlboro, NJ (US); Gary Balaban, Old Bridge, NJ (US)

(72) Inventors: Joseph J. Cilea, Marlboro, NJ (US); Gary Balaban, Old Bridge, NJ (US)

(21) Appl. No.: 13/854,086

(22) Filed: Mar. 30, 2013

Related U.S. Application Data
(60) Provisional application No. 61/618,611, filed on Mar. 30, 2012.

(51) Int. Cl. A61H 23/00

(52) U.S. Cl. CPC A61H 23/006
USPC 601/108

(57) ABSTRACT

A handle and trigger activating a battery powered motor moving a mechanical plunger in a linear motion range. The plunger is placed against a patient's muscle, fascia, tendon, or ligament and is subjected to the repetitive mechanical plunger motion resulting in a deep massage. Plungers of differing shapes, sizes, contours, textures, and hardness may be used and are readily changed. The speed of the device is controlled by the trigger so that if more speed is desired, a user simply depresses the trigger further. Operational modes include: the device set to 30 seconds on the highest power setting, 30 seconds on a middle power setting; the device set to 20 seconds on the highest power setting, 20 seconds on a middle power setting; and the device set to 10 seconds on the highest power setting, 10 seconds on a middle power setting.

### CROSS REFERENCE TO RELATED APPLICATIONS

This application claims priority from U.S. Patent Application Ser. No. 61/618611, entitled “Hand Held Percussion Device”, filed on 30 Mar. 2012. The benefit under 35 USC §119e of the United States provisional application is hereby claimed, and the aforementioned application is hereby incorporated herein by reference.

### TECHNICAL FIELD OF THE INVENTION

The present invention relates generally to a medical percussion device. More specifically, the present invention relates to a hand held percussion device for the purpose of addressing soft tissue (muscle, fascia, tendon, and ligaments) dysfunction and pain syndromes.

### BACKGROUND OF THE INVENTION

Much of muscle pain stems from various conditions, strain, lactic-acid buildup, scar tissue, etc. The present invention uses percussion to reach deep into the muscle tissue to stimulate cellular healing and repair. No other device on the market matches the effectiveness of the present invention.

Therefore, what is needed is a device that creates functional percussive forces, which in turn, facilitate the patient with the benefits of: Increased circulation, Reduced pain, Faster rehabilitation from injury, Increased lymphatic flow, Break up of muscular scar tissue, Reduced lactic acid build up, Tissue regeneration, Soft & active tissue release, Stimulation of growth factor, osteoblasts, and chondroblasts.

### SUMMARY OF THE INVENTION

The present invention is a hand held percussion device for the purpose of addressing soft tissue (muscle, fascia, tendon, and ligaments) dysfunction and pain syndromes. The Device will be used in a Physical Therapy, Physical Medicine, or Chiropractic setting.

The device provides a handle and trigger for activating the device. When activated, an internal, electric battery powered motor actuates a mechanical plunger which operates in a linear motion range. The plunger is placed against a patient's muscle, fascia, tendon, or ligament and is subjected to the repetitive mechanical plunger motion resulting in a deep massage. Various plungers of differing shapes, sizes, contours, textures and hardness may be used and it is possible that the plungers will be easily or readily changed. Additionally, the speed of the device is controlled by the trigger so that if more speed is desired, a user simply depresses the trigger further.

The present invention may be used on the skin or over clothes. First a user selects a removable head size and attaches to the plunger. A user then presses the on/off button to power instrument. Next the speed and power setting are selected and the device is applied to the area. Upon completion of treatment, the removable heads are cleaned if the device was used on skin for sanitary purposes.

The device has five novel and non-obvious features. The novel and non-obvious features are as follows: Stronger power, Variable power, Changeable heads, Modes, and a Cordless/Charges in cradle.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a side planar view of the device; and

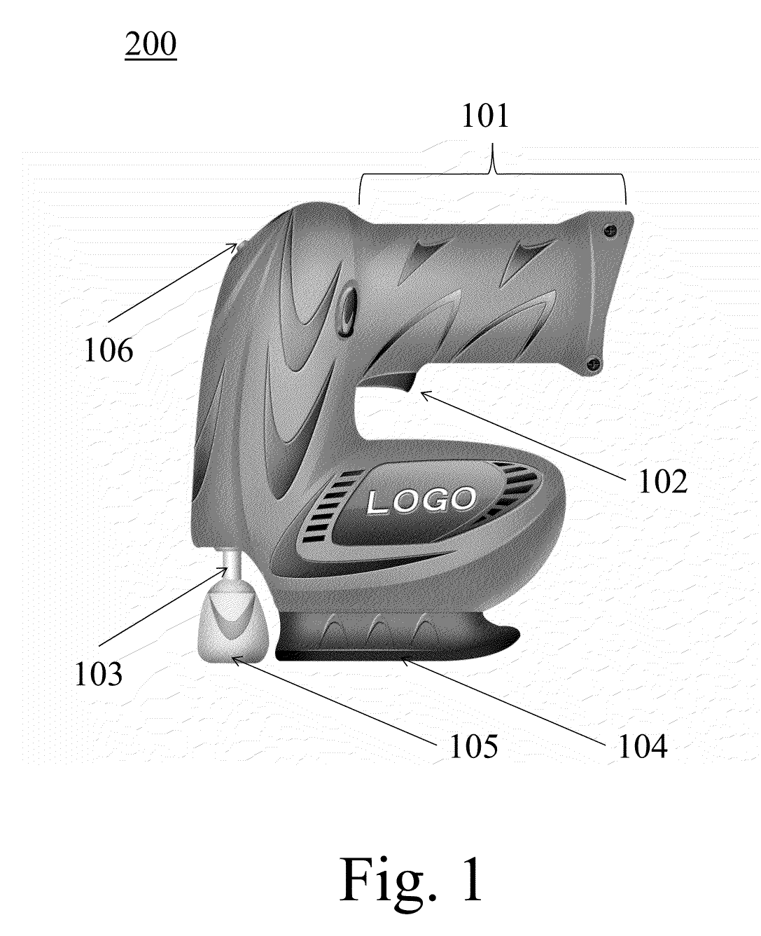

FIG. 2 is a top planar view of the charging station of the device;

FIG. 3 is a side planar view of the charging station of the device; and

FIG. 4 illustrates three modes of operation of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Much of muscle pain stems from various conditions, strain, lactic-acid buildup, scar tissue, etc. The present invention uses percussion to reach deep into the muscle tissue to stimulate cellular healing and repair. No other device on the market matches the effectiveness of the present invention.

The present invention creates functional percussive forces, which in turn, facilitate the patient with the benefits of: Increased circulation, Reduced pain, Faster rehabilitation from injury, Increased lymphatic flow, Break up of muscular scar tissue, Reduced lactic acid build up, Tissue regeneration, Soft & active tissue release, Stimulation of growth factor, osteoblasts, and chondroblasts.

The present invention's unique, comfortable design allows a physician to accurately and comfortably treat muscle and tendon injuries. The present invention has several customized modes for various treatment protocols. The hand held percussion device 100 also provides the ability to vary the frequency depending on area of anatomy and also is designed with interchangeable heads to provide flexibility based on area of anatomy.

The present invention is a hand held percussion device 100 for the purpose of addressing soft tissue (muscle, fascia, tendon, and ligaments) dysfunction and pain syndromes. The hand held percussion device 100 will be used in a Physical Therapy, Physical Medicine, or Chiropractic setting.

The hand held percussion device 100 provides a handle 101 containing a rechargeable battery stored therein, and trigger 102 for activating the hand held percussion device 100. When activated, an internal, electric battery powered motor actuates an external mechanical plunger 103 which operates in a linear motion range. The external mechanical plunger 103 and bottom guide surface 104 is placed against a patient's muscle, fascia, tendon, or ligament and is subjected to the repetitive mechanical plunger motion resulting in a deep massage. Various external mechanical plungers 103 of differing shapes, sizes, contours, textures and hardness may be used and it is possible that the external mechanical plungers 103 will be easily or readily changed. Additionally, the speed of the hand held percussion device 100 is controlled by the trigger 102 so that if more speed is desired, a user simply depresses the trigger 102 further.

The hand held percussion device 100 may be used on the skin or over clothes. First a user selects a removable head 105 of desired size, contour, texture, and hardness and attaches the removable head 105 to the external mechanical plunger 103. A user then presses the on/off button 106 to power the hand held percussion device 100. Next the speed setting and power setting are selected and hand held percussion device 100 is applied to the area. Upon completion of treatment, the removable heads 105 are cleaned if the hand held percussion device 100 was used on skin for sanitary purposes.

The hand held percussion device 100 has five novel and non-obvious features. The novel and non-obvious features are as follows: stronger power, variable power, changeable heads 105, modes 400, and a cordless/charges in cradle 200.

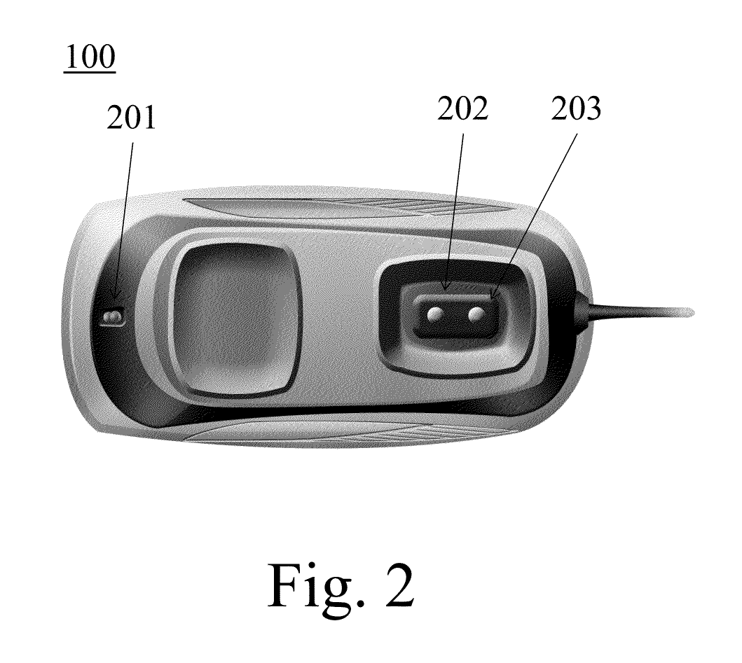

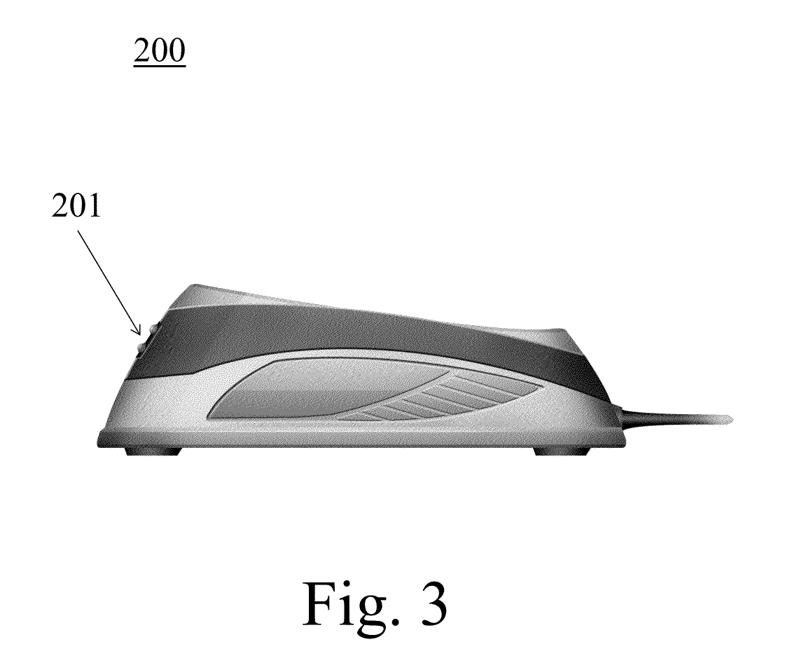

Now referring to FIGS. 2-3, the charging cradle 200 is shown. The hand held percussion device 100 is placed against the two charging electrodes 202 and 203 for transmitting an electrical charge from the charging cradle 200 to a rechargeable battery retained within the handle 101 of the hand held percussion device 100. A light indicator 201 provides a red light to show a charging status and a green light to indicate a fully charged status.

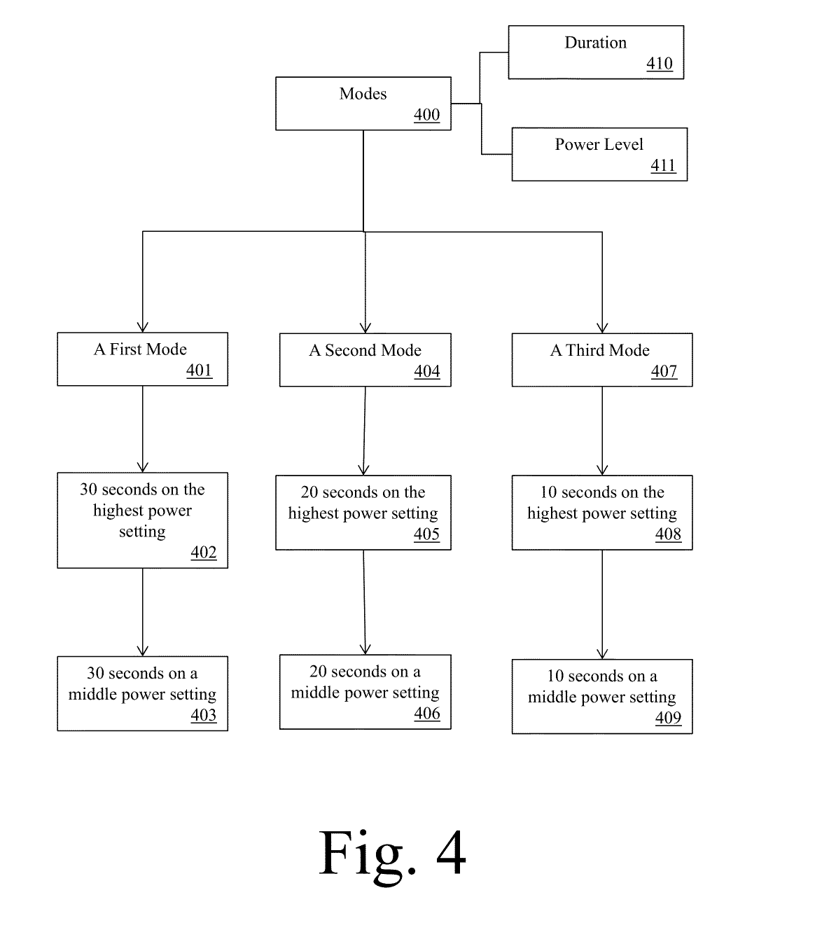

The present invention teaches three modes 400 of operation as illustrated in FIG. 4. A First Mode 401 where the device is set to 30 seconds on the highest power setting 402, and 30 seconds on a middle power setting 403. A Second Mode 404 where the device is set to 20 seconds on the highest power setting 405, and 20 seconds on a middle power setting 406. A Third Mode 407 where the device is set to 10 seconds on the highest power setting 408, 10 seconds on a middle power setting 409.

In an alternative embodiment of the present invention, these modes will be customizable with respect to duration 410, and power level 411.

The hand held percussion device 100 also concentrates on general or local muscle spasms. It increases muscle metabolism and increases the lactic acid cycle to relieve pain. Deep, rapid, short-duration percussion is the key to the elimination of pain.

The hand held percussion device 100 increases the circulation of blood and flow of lymph. The direct mechanical effect of rhythmical pressure and movement used in Functional Percussion Therapy (FPT) with The present invention can dramatically facilitate and increase the rate of blood flow by stimulating nerve receptors that cause the blood vessels to dilate. This effect creates an immediate patient result. FPT with the hand held percussion device 100 can help loosen contracted, shortened muscles and can stimulate weak, flaccid muscles, which can help improve posture and promote more efficient movement.

The hand held percussion device 100 is also being used to complement many soft tissue treatments including PNF, ART, Graston Technique and many more manual therapy techniques. FPT also provides a gentle stretching action to both the muscles and connective tissues that surround and support the muscles and many other parts of the body, which helps keep these tissues elastic to improve responsiveness and performance. FPT also aids recovery from soft tissue injuries such as sprains and strains. This is possible because the growth and repair of tissue are accelerated by efficient circulation in the injured areas and appropriate stimulation of the healing tissues.

FPT is an exciting frontier of soft tissue treatment. The hand held percussion device 100 was designed by physicians to provide a comprehensive treatment approach for many common injuries including: Chronic Trigger Points, Piriformis Syndrome, Sciatica, Cervical, Thoracic and Lumbar Pain, Iliotibial Band Syndrome, Hip Flexor Tendonitis, Hip Bursitis, Carpal Tunnel Syndrome, Plantar Fasciitis, Medial and Lateral Epicondylitis, Rotator Cuff Tendonitis, Muscle/Tendon/Ligament Sprain/Strain, and Dequervain's and Wrist Tendonitis.

Extensive research has shown that the targeted application of acoustic pressure waves create a cellular response that stimulates tissue healing and regeneration. These waves produce micro trauma to the soft tissue and hard tissue including fascia, muscles, bones, ligaments, and tendons, leading to an inflammatory response and thus increasing metabolic processes and regeneration of healthy tissue. This includes the increase in osteo and chondroblasts as well as phagocytosis to accelerate tissue repair and healing.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A handheld percussion device comprising:
a housing;
a handle retaining a rechargeable battery therein;
a trigger for activating the device;
a plunger with a removable head attachment;
an internal, electric battery powered motor actuates a mechanical plunger which operates in a linear motion range;
a plurality of plungers of differing shapes, sizes, contours, textures and hardness;
the plunger head will be easily or readily changed; and
the speed of the device variable and controlled by the trigger, whereby if more speed is desired, the trigger is depressed further.

2. The device of claim 1, further comprising:
a first mode of operation where the device is set to 30 seconds on the highest power setting, 30 seconds on a middle power setting;

3. The device of claim 2, further comprising:
a second mode of operation where the device is set to 20 seconds on the highest power setting, 20 seconds on a middle power setting.

4. The device of claim 3, further comprising: and
a third mode of operation where the device is set to 10 seconds on the highest power setting, 10 seconds on a middle power setting.

5. The device of claim 1, further comprising:
three modes of operation:
a first mode where the device is set to 30 seconds on the highest power setting, 30 seconds on a middle power setting;
a second mode where the device is set to 20 seconds on the highest power setting, 20 seconds on a middle power setting; and
a third mode where the device is set to 10 seconds on the highest power setting, 10 seconds on a middle power setting.

6. The device of claim 5, wherein the three modes of operation are customizable with respect to duration.

7. The device of claim 5, wherein the three modes of operation are customizable with respect to the power setting.

8. The device of claim 7, wherein the power setting is variable for each mode.

9. The device of claim 1, further comprising a cordless charger in a cradle.
